(19) United States
(12) Patent Application Publication
(10) Pub. No.: US 2016/0048184 A1
(43) Pub. Date: Feb. 18, 2016

(54) SHARING FIRMWARE AMONG AGENTS IN A COMPUTING NODE

(71) Applicant: Hewlett-Packard Development Company, L.P., Houston, TX (US)

(72) Inventors: Barry S Basile, Houston, TX (US); Andrew Brown, Houston, TX (US); Jared K Francom, Cypress, TX (US); Michael Stearns, Cypress, TX (US); Chanh V Hua, Houston, TX (US); Darren J Cepulis, Houston, TX (US); Peter Hansen, Cypress, TX (US)

(73) Assignee: Hewlett-Pacakard Development Company, L.P., Houston, TX (US)

(21) Appl. No.: 14/781,299

(22) PCT Filed: Mar. 29, 2013
(86) PCT No.: PCT/US13/34532

§ 371 Date: Sep. 29, 2015

(51) Int. Cl. G06F 1/26; G06F 13/20; G06F 13/42; G06F 9/445

(52) U.S. Cl. CPC G06F 1/266; G06F 8/65; G06F 13/20; G06F 13/4282

(57) ABSTRACT

Sharing firmware among a plurality of agents including a plurality of central processing units (CPUs) on a node is described. In an example, a computing node includes: a bus; a non-volatile memory, coupled to the bus, to store firmware for the plurality of agents; a power sequencer to implement a power-up sequence for the plurality of CPUs; a plurality of power control state machines respectively controlling states of the plurality of CPUs based on output of the power sequencer; and a bus controller to selectively couple the plurality of agents to the non-volatile memory based on state of the plurality of power control state machines.

### BACKGROUND

Computer systems include non-volatile memory to store the first code executed when powered on or “booted”. This non-volatile memory can be referred to as “firmware”. The code of the firmware can provide a firmware interface, such as a basic input/output system (BIOS), unified extensible firmware interface (UEFI), or the like. At least a portion of the code of the firmware can be updatable. The current state of updateable code in the firmware is referred to as an “image.” Thus, a current image of the firmware can be replaced with a new image. A firmware update process can involve erasing and reprogramming non-volatile memory of the firmware.

Modern computers often have multiple processors that provide improved processing speed and performance over a single processor system. Typically, each processor in the system has dedicated firmware that enables the processor to load an operating system (OS). The dedicated firmware is stored in a separate non-volatile memory for each of the processors. To upgrade the firmware, the updated firmware needs to be loaded into each of the memories for each of the processors.

### BRIEF DESCRIPTION OF THE DRAWINGS

Some embodiments of the invention are described with respect to the following figures:

FIG. 1 is a block diagram of a computing node according to an example implementation.

FIG. 2 is a block diagram of a firmware subsystem for the computing node of FIG. 1 according to an example of the invention.

FIG. 3 is a block diagram depicting a computer system according to an example of the invention.

FIG. 4 is a flow diagram depicting a method of sharing firmware among a plurality of agents including a plurality of CPUs connected to a bus on a node according to an example implementation.

FIG. 5 is a flow diagram depicting a method of controlling CPU states according to an example of the invention.

### DETAILED DESCRIPTION

Sharing firmware among agents in a computing node is described. In an example, a non-volatile memory is coupled to a bus to store firmware for a plurality of agents, which includes a plurality of central processing units (CPUs). A power sequencer implements a power-up sequence for the plurality of CPUs. A plurality of control state machines respectively controls states of the CPUs based on output of the power sequencer. A bus controller selectively couples the agents to the non-volatile memory based on state of the power control state machines. In this manner, a single non-volatile memory can be shared among a plurality of agents to store firmware. Moreover, the bus controller arbitrates access to the non-volatile memory among the CPUs based on output of the power sequencer. This coupling between the firmware access arbitration and power sequencing allows the CPUs to obtain and execute firmware when they need to based on any specific power-up sequence.

In an example, a combination of hardware and software can be used to manage shared access to a single non-volatile memory device that contains firmware used to boot multiple central processing units (CPUs). A management agent can be used to update the firmware when the non-volatile memory is not being used by any of the CPUs so that all CPUs can see the update at the same time. The non-volatile memory can be used to store firmware for other agents in the computing node. Sharing a single non-volatile memory with firmware among a plurality of agents reduces node cost and requires less real estate. Since there is only a single non-volatile memory with firmware, there is a single update point for the firmware for all agents. This can save update time. In an example, the management agent can have exclusive rights to write to the non-volatile memory in order to provide a greater level of security against corruption by malicious software running on the CPUs.

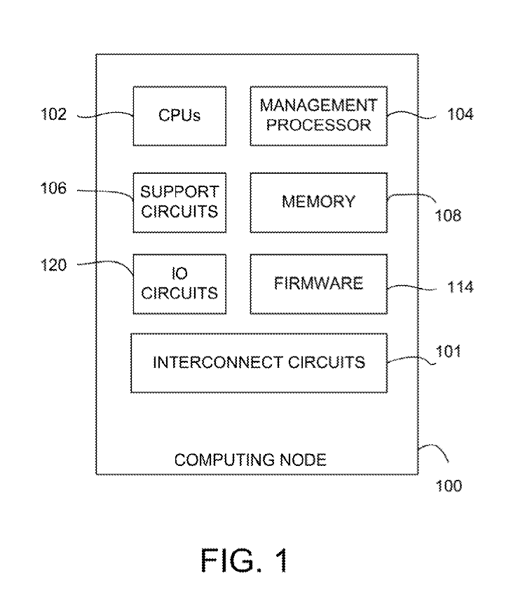

FIG. 1 is a block diagram of a computing node 100 according to an example implementation. The computing node 100 can be a single computer system, or part of a larger computer system comprising a plurality of such computing nodes. The computing node 100 includes a plurality of central processing units (CPUs) 102, a management processor 104, various support circuits 106, memory 108, various input/output (IO) circuits 120, firmware 114, and interconnect circuits 101. The interconnect circuits 101 can provide busses, bridges, and the like to facilitate communication among the components of the computer system 100. The CPUs 102 can include any type of microprocessors known in the art. The support circuits 106 can include cache, power supplies, clock circuits, data registers, and the like. The memory 108 can include random access memory, read only memory, cache memory, magnetic read/write memory, or the like or any combination of such memory devices.

The management processor 104 can include any type of microprocessor, microcontroller, microcomputer, or the like. The management processor 104 provides an interface between a system management environment and the hardware components of the computing node 100, including the CPUs 102, the support circuits 106, the memory 108, the IO circuits 120, and/or the firmware 114. In some implementations, the management processor 104 can be referred to as a baseboard management controller (BMC). The management processor 104 and its functionality are separate from that of the CPUs 102.

The firmware 114 can include a non-volatile memory storing code for used by various devices in the node 100, including the CPUs 102. The firmware can include a BIOS, UEFI, or the like. The firmware 114 can also include code first executed by the CPUs 102 upon boot or reset referred to as “boot code”. The term “non-volatile memory” as used herein can refer to any type of non-volatile storage. Examples include read only memory (ROM), electronically eraseable and programmable ROM (EEPROM), FLASH memory, ferroelectric random access memory (F-RAM), and the like, as well as combinations of such devices.

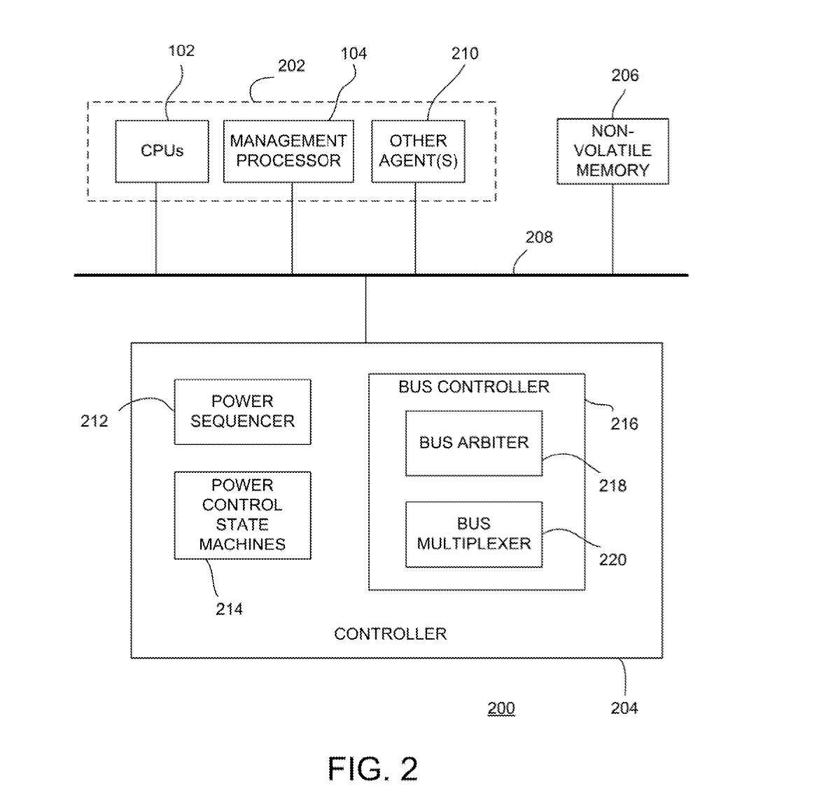

FIG. 2 is a block diagram of a firmware subsystem 200 for the computing node 100 according to an example of the invention. The firmware subsystem 200 includes a plurality of agents 202, a controller 204, a non-volatile memory 206, and a bus 208. The agents 202 can include the CPUs 102 and the management processor 104. In an example, the agents 202 can include at least one other agent (“other agent(s) 210”). The non-volatile memory 206 stores the firmware 114. The firmware 114 can include code for execution by each of the agents 202. The bus 208 can be a serial data bus, such as a serial peripheral interface (SPI) bus or the like. In another example, the bus can by any type of bus, including a parallel bus. The agents 202, the controller 204, and the non-volatile memory 206 are coupled to the bus 208 for communication.

The controller 204 can include a power sequencer 212, a plurality of power control state machines 214, and a bus controller 216. In an example, the controller 204 can be an integrated circuit, such as an application specific integrated circuit (ASIC), a programmable logic device (PLD) (e.g., a complex programmable logic device (CPLD) or field programmable gate array (FPGA)), or the like. In an example, one or more of the power sequencer 212, the plurality of power control state machines 214, and the bus controller 216 can be circuits implemented in the integrated circuit. In an example, one or more of the power sequencer 212, the control state machines 214, and the bus controller 216 can be implemented as software executed by a processor in the integrated circuit. In another example, the elements of the controller 204 can be implemented using a combination of hardware circuits and software.

The power sequencer 212 implements a power-up sequence for the CPUs 102. In an example. The power sequencer 212 selects one CPU at a time for power-up. After a given CPU has completed its power-up, the power sequencer 212 selects another CPU. In this manner, the CPUs 102 are powered-up sequentially and not all at the same time. The terms “power-on” and “power-up” are used synonymously herein. Generally, a CPU “powers-on” by looking to execute instructions starting at a particular predefined location (e.g., a reset vector).

The power control state machines 214 control states of the CPUs 102 based on output of the power sequencer 212. In an example, each of the CPUs can be in various states, such as powered-off, reset, powered-on, as well as any of various partially powered states (e.g., various sleep states). Each of the CPUs 102 includes a dedicated power control state machine 214. In an example, the power control state machines 214 hold each of the CPUs 102 that is not being powered-on in a reset state.

The bus controller 216 selectively couples the agents 202 to the non-volatile memory 206 based on state of the power control state machines 214. When a power control state machine 214 indicates that one of the CPUs 102 is to be powered-on, the bus controller 216 couples the selected CPU 102 to the non-volatile memory 206. In an example, the bus controller 216 includes a bus arbiter 218 and a bus multiplexer 220. The bus arbiter 218 selects any of the agents 202 for communication with the non-volatile memory 206 over the bus 208. That is, the bus arbiter 218 grants bus access to one agent at a time. The bus arbiter 218 can grant bus access to each CPU 102 as such CPU is powered-on based on output of the power control state machines 214 (and indirectly output of the power sequencer 212). The bus multiplexer 220 establishes a communication link between the non-volatile memory and the agent 202 selected by the bus arbiter 218. It is to be understood that the bus controller 216 may have a different configuration based on different types of known busses that can be used with the invention. In general, the bus controller 216 facilitates shared access to the non-volatile memory 206 among the plurality of agents 202. Once a CPU 102 has access to the non-volatile memory 206, the CPU 102 can retrieve its firmware and perform power-up.

The bus controller 216 can receive additional input for granting bus access to agents 202 other than the CPUs 102. For example, the bus controller 216 can service bus access requests from other agents 202 for access to the non-volatile memory 206. In an example, the management processor 104 can send such requests to the bus controller 216. The management processor 104 can request access to the non-volatile memory 206 in order to write and/or read the firmware. For example, the management processor 104 can write various image(s) of the firmware to the non-volatile memory (e.g., upgraded firmware for any of the agents 202). Any of the other agents 210 can similar request access to the non-volatile memory for writing and/or reading firmware stored therein.

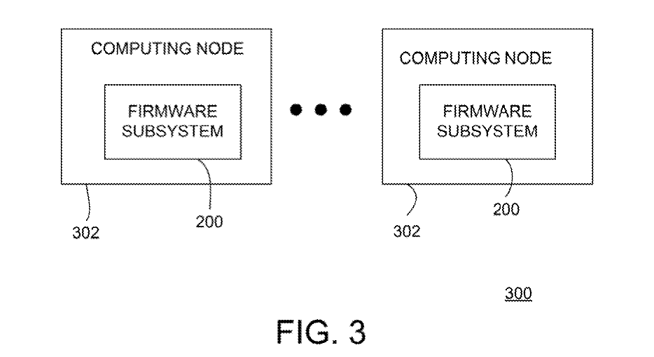

FIG. 3 is a block diagram depicting a computer system 300 according to an example of the invention. The computer system 300 includes a plurality of computing nodes 302. Each of the computing nodes 302 can be configured similar to the computing node 100. Each of the computing nodes 302 can include a firmware subsystem 200 similar to that shown in FIG. 2. That is, each computing node 302 includes a plurality of agents that have shared access to firmware in a non-volatile memory. The agents include a plurality of CPUs that obtain shared access to the non-volatile memory to retrieve their firmware for power-on and booting.

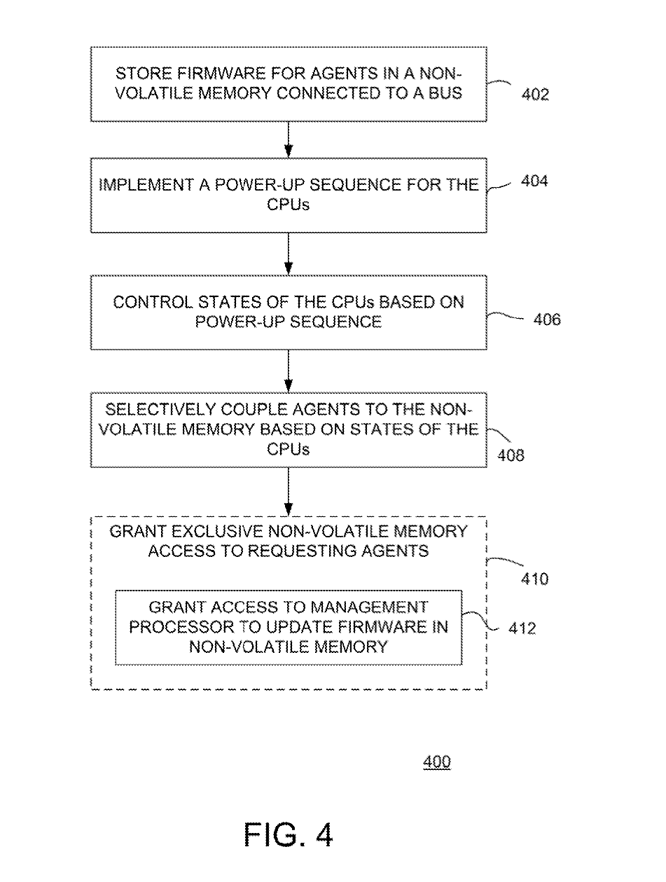

FIG. 4 is a flow diagram depicting a method 400 of sharing firmware among a plurality of agents including a plurality of CPUs connected to a bus on a node according to an example implementation. The method 400 begins at step 402, where firmware is stored in a non-volatile memory connected to a bus for the plurality of agents. At step 404, a power-up sequence is implemented for the plurality of CPUs. At step 406, states of the plurality of CPUs are controlled based on the power-up sequence. At step 408, the agents are selectively coupled to the non-volatile memory based on the states of the CPUs.

At step 410, additional request(s) can be made for access to the non-volatile memory and exclusive access granted to the requesting agents. In particular, at step 412, a management processor can be granted access to the non-volatile memory to update firmware stored therein.

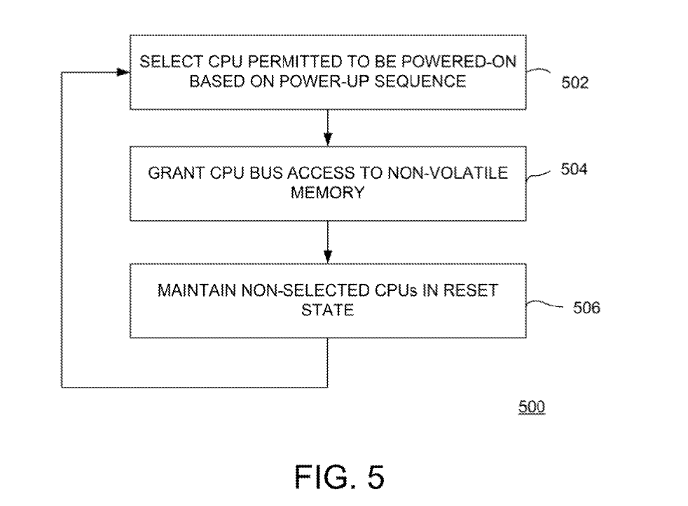

FIG. 5 is a flow diagram depicting a method 500 of controlling CPU states according to an example of the invention. The method 500 can be performed at step 406 in the method 400. At step 502, a CPU permitted to be powered-on is selected based on the power-up sequence. At step 504, the CPU is granted bus access to the non-volatile memory. At step 506, each of the other CPUs are maintained in a reset state. The method 500 can then repeat for each CPU.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus to share firmware among a plurality of agents including a plurality of central processing units (CPUs) on a node, comprising:
a bus;
a non-volatile memory, coupled to the bus, to store firmware for the plurality of agents;
a power sequencer to implement a power-up sequence for the plurality of CPUs;
a plurality of power control state machines respectively controlling states of the plurality of CPUs based on output of the power sequencer;
a bus controller to selectively couple the plurality of agents to the non-volatile memory based on state of the plurality of power control state machines.

2. The apparatus of claim 1, wherein the bus controller includes:
a bus arbiter to select one of the plurality of agents for communication with the non-volatile memory; and
a bus multiplexer to establish a communication link between the non-volatile memory and the one of the plurality of agents as selected by the bus arbiter.

3. The apparatus of claim 1, wherein the bus is a serial data bus.

4. The apparatus of claim 1, wherein the plurality of agents further includes a management agent to load images of the firmware to the non-volatile memory.

5. The apparatus of claim 1, wherein each of the plurality of power control state machines hold a respective one of the plurality of CPUs in reset until selected by the power sequencer for power-up.

6. A method of sharing firmware among a plurality of agents including a plurality of central processing units (CPUs) connected to a bus on a node, comprising:
storing firmware for the plurality of agents in a non-volatile memory coupled to the bus;
implementing a power-up sequence for the plurality of CPUs;
controlling states of the plurality of CPUs based on the power-up sequence; and
selectively coupling the plurality of agents to the non-volatile memory based on the states of the plurality of CPUs.

7. The method of claim 6, wherein the step of controlling the states comprises:
selecting a CPU of the plurality of CPUs permitted to power-up based on the power-up sequence;
granting the CPU access to the non-volatile memory;
maintain each of the plurality of CPUs other than the selected CPU in a reset state; and
repeating the steps of selecting, granting, and maintaining for at least one additional CPU of the plurality of CPUs.

8. The method of claim 6, further comprising:
granting a management process access to the non-volatile memory to update the firmware stored therein.

9. The method of claim 6, further comprising:
receiving requests for access to the non-volatile memory from requesting agents of the plurality of agents; and
successively granting exclusive access to the requesting agents based on the requests.

10. The method of claim 6, wherein the bus is a serial data bus.

11. A computer system, comprising:
at least one node, including:
a plurality of agents including a plurality of central processing units (CPUs);
a bus;
a non-volatile memory coupled to the bus, to store firmware for the plurality of agents; and
an integrated circuit, coupled to the bus, including:
a power sequencer to implement a power-up sequence for the plurality of CPUs;
a plurality of power control state machine respectively controlling states of the plurality of CPUs based on output of the power sequencer circuit;
a bus controller to selectively couple the plurality of agents to the non-volatile memory based on state of the plurality of power control state machine circuits.

12. The computer system of claim 11, wherein the bus controller includes:
a bus arbiter to select one of the plurality of agents for communication with the non-volatile memory; and
a bus multiplexer to establish a communication link between the non-volatile memory and the one of the plurality of agents as selected by the bus arbiter.

13. The computer system of claim 11, wherein the bus is a serial data bus.

14. The computer system of claim 11, wherein the plurality of agents further includes a management agent to load images of the firmware to the non-volatile memory.

15. The computer system of claim 11, wherein each of the plurality of power control state machine hold a respective one of the plurality of CPUs in reset until selected by the power sequencer for power-up.
